(19) United States
(12) Patent Application Publication
(10) Pub. No.: US 2026/0228558 A1
(43) Pub. Date: Aug. 6, 2026

(54) METHODS AND NODES IN A COMMUNICATIONS NETWORK FOR TRAINING AN AUTOENCODER

(71) Applicant: Telefonaktiebolaget LM Ericsson (publ), Stockholm (SE)

(72) Inventors: Abdulrahman ALABBASI, Kista (SE); Konstantinos VANDIKAS, Solna (SE); Illyyne SAFFAR, Le plessis-Robinson (FR); Aurelie BOISBUNON, Massy (FR)

(73) Assignee: Telefonaktiebolaget LM Ericsson (publ), Stockholm (SE)

(21) Appl. No.: 19/149,984

(22) PCT Filed: Sep. 29, 2023
(86) PCT No.: PCT/SE2023/050968

§ 371 Date: Jul. 22, 2025

(30) Foreign Application Priority Data
Jan. 23, 2023 (GR) 20230100050

(51) Int. Cl. G06N 3/098; G06N 3/0455

(52) U.S. Cl. CPC G06N 3/098; G06N 3/0455

(57) ABSTRACT

A computer-implemented method in a first node in a communications network for training a first component model of an Autoencoder, AE, machine learning model, the first component model being either an encoder or a decoder and wherein the first component model is for use in exchanging compressed Channel State Information (CSI) between the first node, a second node, and a third node in the communications network. The method comprises: i) training (502) the first component model using a first data product obtained from the second node, wherein the training comprises freezing a first subset of horizontal layers in the first component model during a first backward pass training stage. The method further comprises ii) initiating (504) further training of the first component model using a second data product from the third node, wherein the further training comprises freezing a second subset of horizontal layers in the first component model during a second backward pass training stage, the first subset of horizontal layers being different to the second subset of horizontal layers.

### TECHNICAL FIELD

This disclosure relates to methods, nodes and systems in a communications network. More particularly but non-exclusively, the disclosure relates to methods and nodes in a communications network for training a first component model of an Autoencoder machine learning model.

### BACKGROUND

The 5^{th} generation (5G) mobile wireless communication system (known as new radio, “NR”) uses Orthogonal Frequency-Division Multiplexing (OFDM) with configurable bandwidths and subcarrier spacing to efficiently support a diverse set of use-cases and deployment scenarios. With respect to the 4^{th} generation system (known as Long Term Evolution, “LTE”), NR improves deployment flexibility, user throughputs, latency, and reliability. The throughput performance gains are enabled, in part, by enhanced support for Multi-User Multiple-Input Multiple-Output (MU-MIMO) transmission strategies, where two or more UEs receive data on the same time frequency resources, e.g., spatially separated transmissions.

If the network (NW) cannot accurately estimate the full downlink channel from uplink transmissions, then active User Equipments (UEs) need to report channel information to the NW over the uplink control or data channels. In LTE and NR, this feedback can be performed using the following signalling protocol:
The NW transmits Channel State Information reference signals (CSI-RS) over the downlink using N ports.
The UE estimates the downlink channel (or important features thereof) for each of the N ports from the transmitted CSI-RS.
The UE reports CSI (e.g., channel quality index (CQI), precoding matrix indicator (PMI), rank indicator (RI)) to the NW over an uplink control and/or data channel.
The NW uses the UE's feedback for downlink user scheduling and MIMO precoding.

In NR, there are two types of beamforming. Type I selects only one specific beam from a group of beams while type 2 selects a group of beams and linearly combines all the beams in the same group. Both Type I and Type II reporting is configurable, where the CSI Type II reporting protocol has been specifically designed to enable MU-MIMO operations from uplink UE reports.

The CSI Type II normal reporting mode is based on the specification of sets of Discrete Fourier Transform (DFT) basis functions in a precoder codebook. The UE selects and reports the L DFT vectors from the codebook that best match its channel conditions (like the classical codebook precoding matrix indicator (PMI) from earlier 3GPP releases). The number of DFT vectors L is typically 2 or 4 and it is configurable by the NW. In addition, the UE reports how the L DFT vectors should be combined in terms of relative amplitude scaling and co-phasing.

Recently neural network based autoencoders (AEs) have shown promising results for compressing downlink MIMO channel estimates for uplink feedback.

An AE is a type of neural network (NN) that can be used for the reduction of the data in a representative space/dimension in an unsupervised manner. FIG. 1 illustrates a fully connected (dense) AE. The AE is divided into two parts: an encoder 102 (used to compress the input data X), and a decoder 104 (used to recover/reconstruct the input data from the compressed data output from the encoder).

The encoder and decoder are separated by a bottleneck layer 106 that holds a compressed representation of the input data “X”. The compressed representation is denoted “Y” in FIG. 1. The variable Y is sometimes called the latent representation of the input X.

To decrease communication cost it is desirable that the size of the bottleneck (latent representation) e.g. the size of Y is smaller than the size of the input data X. The AE encoder thus compresses the input features X to produce the latent representation, Y.

The decoder part of the AE tries to invert the encoder's compression and reconstruct X with minimal error, according to some predefined loss function. The decoded, or reconstruction of X, is labelled X\hat{ }.

In AE-based CSI reporting, the AE encoder is in UE and the AE decoder is in the NW. The UE and the NW are typically represented by different vendors (manufacturers), and, therefore, the AE solution needs to be viewed from a multi-vendor perspective with potential standardization (3GPP) impacts (see e.g. 3GPP TSG-RAN WG1, Meeting #109-e, Tdoc R1-2203281, “Evaluation of AI-CSI”, Online, May 16th-27th, 2022; RWS-210448, “Views on studies on AI/ML for PHY,” Huawei-HiSilicon, TSG RAN Rel-18 workshop, June 28-July.)

To this end, 3GPP 5G networks support uplink physical layer channel coding (error control coding) in the following manner:
The UE performs channel encoding and the NW performs channel decoding. The channel encoders have been specified in 3GPP, which ensures that the UE's behaviour is understood by the NW and can be tested.
The channel decoders, on the other hand, are left for implementation (vendor proprietary).

If 3GPP specifies one or more AE-based CSI encoders for use in UEs, then the corresponding AE decoders in the NW can be left for implementation (e.g., constructed in a proprietary manner by training the decoders against specified AE encoders).

The standardization perspectives on AE-based CSI reporting can be summarized as follows:

Examples where AE encoder, or AE decoder, or both are standardized:
Training within 3GPP (e.g., Neural Network (NN) architectures, weights and biases are specified),
Training outside 3GPP (e.g., NN architectures are specified),
Signalling for AE-based CSI reporting/configuration are specified,
Examples where AE encoder and AE decoder are implementation specific (vendor proprietary):
Interfaces to the AE encoder and AE decoder are specified,
Signalling for AE-based CSI reporting/configuration are specified.

### SUMMARY

As noted above in the background section and the references therein, several challenges arise when considering using Autoencoders for compression reported CSI I/Q samples across radio channels, particularly when the encoding and decoding is performed by different vendors. There are different challenges associated with different levels of model and/or data sharing. Such challenges may be summarized as follows:

Scenario 1: Vendors don't want to share their data or models, e.g., Proprietary Data and/or Proprietary AE. The challenge with this scenario is how to produce a reciprocal encoder or decoder, in the absence of the Proprietary Data and/or Proprietary AE.

A compromise between full sharing is considered as:
Opt-1: UE-vendor(s) Share Encoders with gNB(s)
Opt-2: gNB-vendor(s) Share Decoder(s) with UE

Scenario 2: A common real/synthetic data set is shared between NW/UE vendors. Challenges associated with this scenario include but are not limited to: how to train encoders and decoders over the air.

Scenario 3: UE vendors are to design encoders that are compatible with more than one NW decoder, or the NW vendor is to design a decoder that is compatible with more than one UE encoder. In such scenarios, the UE or NW will need to train more than one encoder or decoder respectively, and this can place large restrictions and limitations on the UE or NW respectively due to the overheads associated with loading and unloading the different models as needed. Due to their size, it isn't generally possible to have more than one encoder or decoder occupying the same memory at any given time.

The disclosure herein addresses some of the aforementioned issues through the provision of “global” encoders and/or decoders. For example, in a scenario where there are multiple UEs and a single network node, embodiments herein relate to the provision of a single decoder capable of decoding the latent representation of CSI data received from different encoders located on different UEs. In some embodiments, this is provided in a manner which preserves the privacy of each UE, e.g. the data and the encoders used by each of the UEs does not need to be shared. In a scenario where a UE provides CSI data to multiple network nodes, embodiments herein relate to the provision of a single encoder that can encode the CSI data in a manner that can be decoded by the different decoders on each of the network nodes. In some embodiments, this is provided in a manner which preserves the privacy of each network node, e.g. the data and the decoder used by each of the network nodes does not need to be shared. These and further aspects will be described in more detail below.

Thus, in a first aspect, there is provided a computer-implemented method in a first node in a communications network for training a first component model of an Autoencoder, AE, machine learning model, the first component model being either an encoder or a decoder and wherein the first component model is for use in exchanging compressed Channel State Information (CSI) between the first node, a second node, and a third node in the communications network. The method comprises: i) training the first component model using a first data product obtained from the second node, wherein the training comprises freezing a first subset of horizontal layers in the first component model during a first backward pass training stage; and ii) initiating further training of the first component model using a second data product from the third node, wherein the further training comprises freezing a second subset of horizontal layers in the first component model during a second backward pass training stage, the first subset of horizontal layers being different to the second subset of horizontal layers.

In this way, the first component model is trained using data products from the first and second nodes, with different layers in the first component model being frozen during the training using the different data products. This manner of training has the technical effect of preserving the learnings obtained on each dataset (e.g. the learning from the first UE, the second UE and the third UE) and prevents the phenomenon of “catastrophic forgetting” whereby previous learnings are effectively overwritten by subsequent learnings. This creates a balance between the learnings obtained from each UE. It further allows the model to learn and retain knowledge from rare events or slight differences between CSI data available at the first UE, the second UE and the third UE, resulting in high accuracy.

In some embodiments, preceding steps i) and ii) the method further comprises: training a baseline version of the first component model on first CSI data. The training in step i) may then be performed on the baseline version of the first component model.

In some embodiments, the method further comprises sending the baseline version of the first component model to both the second node and the third node.

In some embodiments the method further comprises receiving the first data product from the second node, the first data product having been obtained as a result of the second node training a second component model to perform a complementary (or opposite/inverse) encoding operation with respect to the baseline version of the first component model, using CSI data available at the second node.

In some embodiments, the method further comprises receiving the second data product from the third node, the second data product having been obtained as a result of the third node training a third component model to perform a complementary encoding operation with respect to the baseline version of the first component model, using CSI data available at the third node.

In some embodiments, the first data product is the second component model and/or the second data product is the third component model.

In some embodiments, step i) comprises using the first component model and the second component model in opposition to one another during the training.

In some embodiments, the first data product comprises a latent representation of the CSI data available at the second node, the latent representation having been obtained by passing the CSI data through the second component model. In some embodiments, the second data product comprises a latent representation of the CSI data available at the third node, the latent representation having been obtained by passing the CSI data through the second component model.

In some embodiments, in step i) the first component model is trained to: decompress the latent representation available at the second or third node if the first component model is a decoder; or compress the CSI data available at the third node to produce the latent representation, if the first component model is an encoder.

In some embodiments, the second component model is an encoder if the first component model is a decoder, and a decoder if the first component model is an encoder. In some embodiments, the third component model is an encoder if the first component model is a decoder and a decoder if the first component model is an encoder.

In some embodiments, the further training is performed by the first node.

In some embodiments, the first node is a first network node, the second node is a first user equipment, UE, the third node is a second UE, and the first component model is a universal decoder for use by the first network node in decoding compressed CSI information from either the first UE or the second UE.

In some embodiments, the method further comprises receiving first compressed CSI data from the first UE, and decompressing the first compressed CSI data, using the first component model; and/or receiving second compressed CSI data from the first UE, and decompressing the second compressed CSI data, using the first component model.

In some embodiments, the first node is a first user equipment, UE, the second node is a first network node, the third node is a second network node, and the first component model is a universal encoder for use by the first user equipment in encoding CSI information that can be decoded by either the first network node or the second network node.

The method may further comprise compressing first CSI data to obtain compressed first CSI data, using the first component model, and sending the compressed first CSI data to the first network node and/or the second network node.

In another group of embodiments, the first data product comprises a baseline version of the first component model that has been trained by the second node on CSI data available at the second node. The method may then comprise training a second component model to perform a complementary encoding operation with respect to the baseline version of the first component model, using CSI data available at the second node, and using the second component model in opposition to the first component model, in order to train the first component model in step i).

In some embodiments, the baseline version of the first component model may be used as the starting point for the first component model in the training in step i).

In some embodiments, the first data product further comprises a first version of the first component model, the first version of the component model having been trained by the second node on CSI data available on the second node, by freezing a third subset of horizontal layers in the first component model during a third backward pass training stage, the third subset of horizontal layers being different to the first subset of horizontal layers and the second subset of horizontal layers. In such embodiments, the method may comprise using the first version of the first component model as the starting point for the first component model in the training in step i).

In some embodiments, the training in step i) is performed using CSI data available at the first node.

In some embodiments, step ii) comprises sending one or more of the following to the third node to initiate the further training on the third node: i) the first component model as output from step i); ii) one or more parameters of the first component model as output from step i); iii) one or more instructions to cause the third node to perform the further training.

In some embodiments, the second data product is CSI data available at the third node.

In some embodiments, the first node is a first user equipment, UE, the second node is a first network node, the third node is a second UE, and the first component model is a universal decoder for use by the first network node in decoding compressed CSI information from either the first UE or the second UE.

In some embodiments, the method further comprises sending the first component model to the first network node for use in decoding compressed CSI data from the first UE and/or the second UE.

In some embodiments, the method further comprises compressing first CSI data; and sending the compressed first CSI data to the first network node.

In some embodiments, the first node is a first network node, the second node is a first user equipment, UE, the third node is a second network node, and the first component model is a universal encoder for use by the first UE in encoding CSI information that can be decoded by either the first network node or the second network node.

In some embodiments, the method further comprises compressing first CSI data using the first component model, and sending the compressed first CSI data to the first network node and/or the second network node.

In a second aspect there is a computer implemented method in a second node in a communications network for training a first component model of an Autoencoder, AE, machine learning model, the first component model being either an encoder or a decoder and wherein the first component model is for use in exchanging compressed Channel State Information (CSI) between the first node, a second node, and a third node in the communications network. The method comprises: receiving from a first node a baseline version of a first component model on CSI data available at the first node; training a second component model to perform a complementary encoding operation with respect to the baseline version of the first component model, using CSI data available at the second node; and sending a first data product based on the training to the first node, for use by the first node in further training of the first component model.

In some embodiments, first data product comprises one or more of the following: the second component model; and a latent representation of the CSI data available at the second node, the latent representation having been obtained by passing the CSI data through the second component model.

In some embodiments, the second component model is an encoder if the first component model is a decoder, and a decoder if the first component model is an encoder.

In some embodiments, the first node is a first network node, the second node is a first user equipment, UE, the third node is a second UE; and wherein the first component model is a universal decoder for use by the first network node in decoding compressed CSI information from either the first UE or the second UE.

In some embodiments, the method further comprises compressing new CSI data using the second component model; and sending the new compressed CSI data to the first network node.

In some embodiments, the first node is a first user equipment, UE, the second node is a first network node, the third node is a second network node and wherein the first component model is a universal encoder for use by the first user equipment in encoding CSI information that can be decoded by either the first network node or the second network node. In some embodiments, the method further comprises receiving new compressed CSI data from the first UE, and decompressing the new compressed CSI data from the first UE, using the second component model.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows a prior art illustration of an autoencoder;

FIG. 2 shows an example network node according to some embodiments herein;

FIG. 3 shows an example User Equipment according to some embodiments herein;

FIG. 4 shows various different use-cases according to embodiments herein;

FIG. 5 shows a method in a first node according to some embodiments herein;

FIG. 6a illustrates a method of training a first component model according to some embodiments herein;

FIG. 6b illustrates the trained model of FIG. 6a in use;

FIG. 7 shows an example autoencoder architecture where the horizontal layers are split into three subsets according to some embodiments herein;

FIG. 8 shows a method 800 in a second node according to some embodiments herein;

FIG. 9 shows an example manner in which to partition data according to some embodiments herein;

FIG. 10 shows an example signal diagram between the nodes illustrated in FIG. 6a;

FIG. 11 shows an example training and execution process according to some embodiments herein;

FIG. 12 shows an example training and execution process according to some embodiments herein;

FIG. 13 shows an example training and execution process according to some embodiments herein; and

FIG. 14 shows an example training and execution process according to some embodiments herein.

### DETAILED DESCRIPTION

The disclosure herein relates to a communications network (or telecommunications network). A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

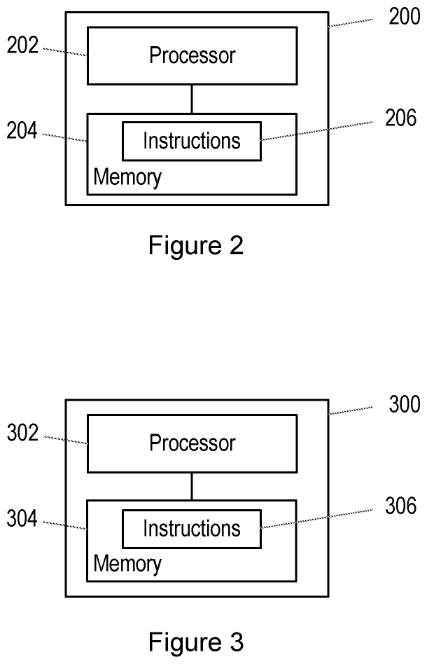

Generally, embodiments herein relate to nodes in a communications network, such as network nodes and User Equipment (UEs). FIG. 2 illustrates an example network node 200 in a communications network according to some embodiments herein. Generally, the network node 200 may comprise any component or network function (e.g. any hardware or software module) in the communications network suitable for performing the functions described herein. For example, a network node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

A network node 200 may be configured (e.g. adapted, operative, or programmed) to perform any of the embodiments of the method 500 or 800 as described below. It will be appreciated that the network node 200 may comprise one or more virtual machines running different software and/or processes. The network node 200 may therefore comprise one or more servers, switches and/or storage devices and/or may comprise cloud computing infrastructure or infrastructure configured to perform in a distributed manner, that runs the software and/or processes.

The network node 200 may comprise a processor (e.g. processing circuitry or logic) 202. The processor 202 may control the operation of the network node 200 in the manner described herein. The processor 202 can comprise one or more processors, processing units, multi-core processors or modules that are configured or programmed to control the network node 200 in the manner described herein. In particular implementations, the processor 202 can comprise a plurality of software and/or hardware modules that are each configured to perform, or are for performing, individual or multiple steps of the functionality of the network node 200 as described herein.

The network node 200 may comprise a memory 204. In some embodiments, the memory 204 of the network node 200 can be configured to store program code or instructions 206 that can be executed by the processor 202 of the network node 200 to perform the functionality described herein. Alternatively or in addition, the memory 204 of the network node 200, can be configured to store any requests, resources, information, data, signals, or similar that are described herein. The processor 202 of the network node 200 may be configured to control the memory 204 of the network node 200 to store any requests, resources, information, data, signals, or similar that are described herein.

It will be appreciated that the network node 200 may comprise other components in addition or alternatively to those indicated in FIG. 2. For example, in some embodiments, the network node 200 may comprise a communications interface. The communications interface may be for use in communicating with other network nodes in the communications network, (e.g. such as other physical or virtual nodes). For example, the communications interface may be configured to transmit to and/or receive from other nodes or network functions requests, resources, information, data, signals, or similar. The processor 202 of network node 200 may be configured to control such a communications interface to transmit to and/or receive from other nodes or network functions requests, resources, information, data, signals, or similar.

As noted above, some embodiments herein relate to User Equipment (UEs) or client devices in a wireless network (e.g. such as stations STAs). In more detail, A UE may comprise a device capable, configured, arranged and/or operable to communicate wirelessly with network nodes and/or other wireless devices. Unless otherwise noted, the term UE may be used interchangeably herein with wireless device (WD). Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc., A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal.

FIG. 3 shows an example UE 300 according to some embodiments herein. UE 300 comprises a processor 302 and a memory 304. In some embodiments, the memory 304 contains instructions 306 executable by the processor 302 to cause the processor to perform the methods and functions described herein.

The UE 300 may be configured or operative to perform the methods and functions described herein such as the method 500 or the method 800. The UE 300 may comprise processor (or logic) 302. It will be appreciated that the UE 300 may comprise one or more virtual machines running different software and/or processes. The UE 300 may therefore comprise one or more servers, switches and/or storage devices and/or may comprise cloud computing infrastructure or infrastructure configured to perform in a distributed manner, that runs the software and/or processes.

The processor 302 may control the operation of the UE 300 in the manner described herein. The processor 302 can comprise one or more processors, processing units, multi-core processors or modules that are configured or programmed to control the UE 300 in the manner described herein. In particular implementations, the processor 302 can comprise a plurality of software and/or hardware modules that are each configured to perform, or are for performing, individual or multiple steps of the functionality of the UE 300 as described herein.

The UE 300 may comprise a memory 304. In some embodiments, the memory 304 of the UE 300 can be configured to store program code or instructions that can be executed by the processor 302 of the UE 300 to perform the functionality described herein. Alternatively or in addition, the memory 304 of the UE 300, can be configured to store any requests, resources, information, data, signals, or similar that are described herein. The processor 302 of the UE 300 may be configured to control the memory 304 of the UE 300 to store any requests, resources, information, data, signals, or similar that are described herein.

It will be appreciated that a UE 300 may comprise other components in addition or alternatively to those indicated in FIG. 3. For example, the UE 300 may comprise a communications interface. The communications interface may be for use in communicating with other UEs and/or nodes in the communications network, (e.g. such as other physical or virtual nodes such as a node 200 as described above). For example, the communications interface may be configured to transmit to and/or receive from nodes or network functions requests, resources, information, data, signals, or similar. The processor 302 of UE 300 may be configured to control such a communications interface to transmit to and/or receive from nodes or network functions requests, resources, information, data, signals, or similar.

As described above, embodiments herein relate to the use of autoencoders in communications networks, for use, for example in compressing downlink MIMO Channel State Information (CSI) estimates for uplink feedback. This may be used, for example in a MU-MIMO system. As described above in the background section, issues can arise when UE vendors (operating UEs such as UE 300) and NW vendors (operating network nodes such as network node 200) use different AEs in these types of processes. This can lead to individual UEs and/or individual NW nodes needing to hold many encoders or decoders in memory at a given time. E.g. currently, a UE sending CSI to more than one NW node may need to use a different encoder for each NW node. Conversely, a NW node receiving compressed CSI data from more than one UE may need a different decoder for each UE's compressed data. As well as being inefficient, AEs are large and this is therefore generally infeasible due to memory constraints.

As also described above, for reasons of privacy, vendors may be reluctant to share their raw CSI data and/or encoders or decoders trained on the raw data with other vendors. This generally means that it isn't feasible to pool data in order to train a single encoder-decoder pair that can be trained on a single global dataset from all nodes in a traditional manner.

In brief, to this end, what is proposed herein is a balanced replay incremental learning (BRIL) mechanism to construct a universal AE (Encoder/Decoder) at both sides of the network (network-vendor(s) or UE-vendor(s) sides) using data processing procedures, and baseline NW Encoder-Decoder training. In a scenario where a plurality of UEs send compressed CSI to a single NW node, a baseline decoder may be trained at the network and this baseline may then be sent to all UEs from multiple vendors, who train their own encoders by freezing the baseline-NW decoder and training their own encoders to encode data available to the respective vendor. The encoders are sent to the NW. The NW then applies a layer- and latent-segmentation process to train a universal decoder. In this segmentation process, the percentage of latent sample size per vendor may also be addressed.

Thus, embodiments herein propose to address some of the aforementioned problems through the training of a global encoder or decoder. For example, a global encoder may be able to encode CSI data that can be decoded by different decoders located on different network nodes, that have been trained on different training data specific to the respective network node. In this way, the training data sets and/or decoders do not necessarily need to be transferred around the network, improving privacy of the respective network nodes. As another example, a global decoder may be able to decode CSI data that has been encoded by different encoders located on different UEs that have been trained on different training data sets (e.g. training data sets specific to their respective UEs). In this way, the training data sets and/or encoders do not necessarily need to be transferred around the network, improving privacy of the respective UEs. Use of a universal or global encoder or decoder has the advantage of reducing the cost of maintaining multiple autoencoders for every combination of UEs (chipset vendors) and NW (network) vendors.

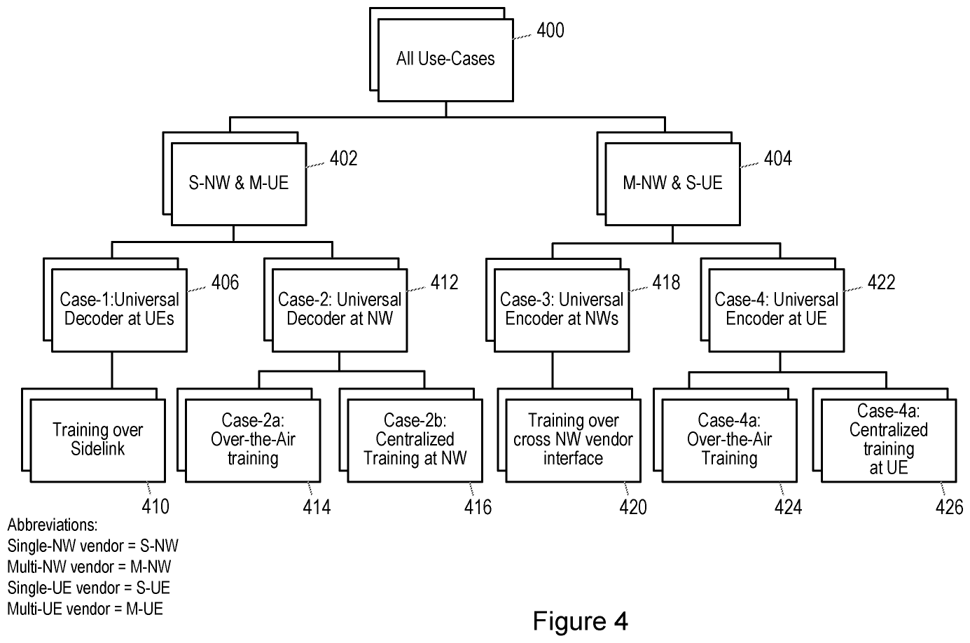

Some example scenarios are illustrated in FIG. 4, which shows various use-cases to which the proposed incremental learning methods described herein can be applied to. The use cases 400 may be split into two branches: Single-Network Node and Multiple UE use cases in branch 402; and Multiple-Network node, single UE use cases in branch 404. These will be discussed in more detail below.

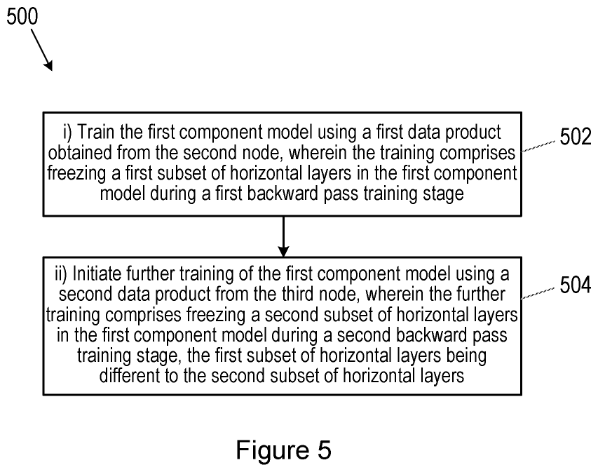

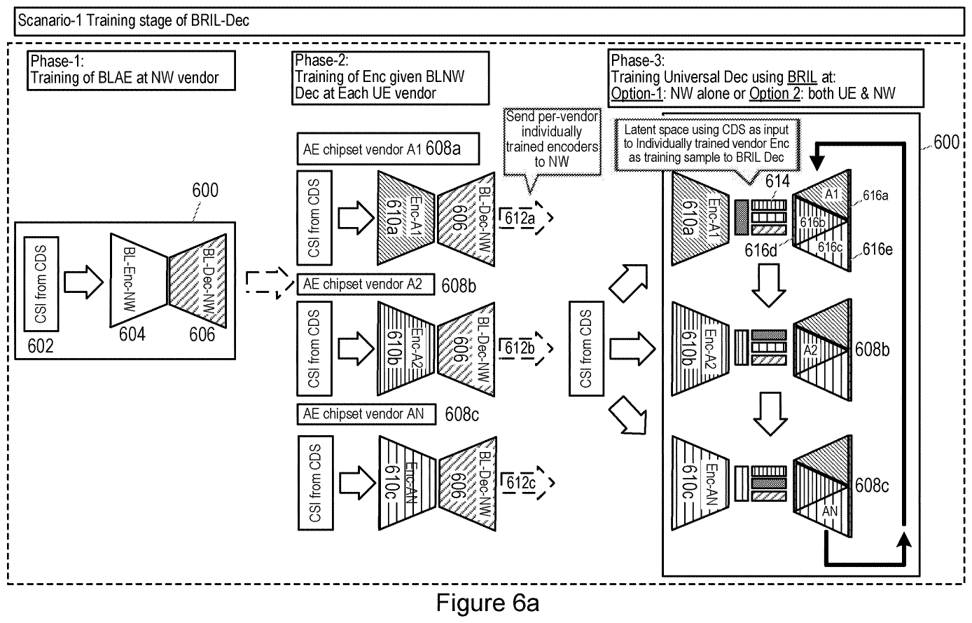

Turning now to FIG. 5, which shows a computer implemented method 500 according to some embodiments herein. The method 500 may be performed by a first node in a communications network. The method 500 is for training a first component model of an Autoencoder, AE, machine learning model. The first component model may be either an encoder or a decoder. The first component model is for use in exchanging compressed Channel State Information (CSI) between the first node, a second node, and a third node in the communications network. In brief, in a first step 502, the method 500 comprises training the first component model using a first data product obtained from the second node, wherein the training comprises freezing a first subset of horizontal layers in the first component model during a first backward pass training stage. In a second step 504, the method comprises initiating further training of the first component model using a second data product from the third node, wherein the further training comprises freezing a second subset of horizontal layers in the first component model during a second backward pass training stage, the first subset of horizontal layers being different to the second subset of horizontal layers.

The first component model is an encoder or a decoder, e.g. one half of an Autoencoder. According to the disclosure herein, the first component model is trained using data products from different nodes, freezing different subsets of horizontal layers for the training using each of the different data products. As will be described in more detail below, the data products may take various forms, for example, the first data product can be: option 1) a second component model (e.g. trained at the third node, or option 2) a latent representation of CSI data available at the third node, the latent representation having been obtained by passing the CSI data through the second component model.

As will be described in more detail below, different subsets of layers may be unfrozen (or updated) during training associated with the second and third nodes. Thus, in this way, different subsets of layers are updated for training related to data products from different nodes. If a particular subset of horizontal layers are unfrozen for training related to a particular node, then these may be subsequently frozen for all other training related to data products from other nodes. In this way, the training, or learnings from the earlier nodes can be “locked in” to the AE. This prevents the phenomenon of catastrophic forgetting and enables the first component model (e.g. the encoder or decoder) to compress or decompress CSI data from the first node, the second node and the third node, at the same time, even when the decompression or compression respectively, is performed by another decoder or encoder that is trained specifically on data from the respective node.

In more detail, generally, the first node can be a network node, such as the network node 200 described above, a UE such as the UE 300 described above, a client device in a Wi-Fi system, or any other node in a communications network.

In some embodiments, preceding steps i) and ii) a baseline version of the first component model is trained on first CSI data. In such embodiments, the training in step i) is performed on the baseline version of the first component model. In other words, a baseline version of the first component model may be used to initialise the first component model. The baseline version of the first component model is an encoder if the first model is an encoder and a decoder if the first component model is a decoder. In other words, the baseline version of the first component model is the same “half” of an autoencoder as the first component model.

The baseline version of the first component model may have been trained at the first node, or alternatively obtained (e.g. received) from another node. The baseline version of the first component model may be one half of a baseline autoencoder (e.g. comprising an encoder and a decoder). A baseline autoencoder model may be trained using any CSI data, for example, including but not limited to CSI data obtained from a repository such as a cloud repository, CSI data available at the first node, and/or synthetic CSI data.

Appendix I shows a header and some example CSI data. The example therein is represented by L3-filtered CSI (not L1). The skilled person will appreciate that this is merely an example and that further or different headers may also be present in the CSI data. For example, CSI data may further comprise fields including but not limited to: SINR, Delay, Number-of-Users and/or Bandwidth.

In other examples, instead of a baseline version of the first component model, a newly initialised version of the first component model may be used in step 502 (e.g. with arbitrary weightings and biases).

Step 502 may comprise obtaining the first data product from the second node. The first data product may have been obtained as a result of the second node training a second component model to perform a complementary encoding operation (e.g. an opposite or inverse encoding/decoding operation) with respect to the baseline version of the first component model, using CSI data available at the second node.

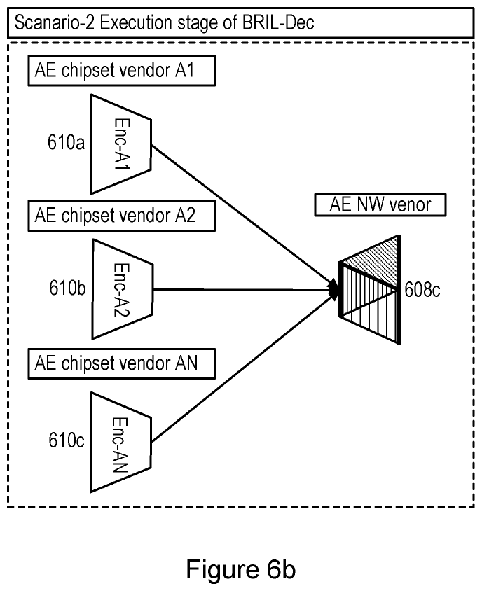

This is illustrated in FIG. 6a, which shows an embodiment of the method 500. In this embodiment, the first node is a network node 600, the second node is a first UE 608a and the second node is a second UE 608b. In this embodiment, the first component model is a decoder. The decoder is for decoding encoded CSI from the first UE and the second UE. In this embodiment, the first UE and the second UE are encoding the CSI using different encoders, that have each been trained on data available to the first UE and the second UE respectively. As such, the first component model is a universal decoder, able to decode compressed CSI from the two different encoders on the first and second UEs.

FIG. 6a illustrates a method of training a global decoder as described in the preceding paragraph. In this embodiment, the steps outlined in Phase 1 are performed at the first node 600 which is a network node; the steps in Phase 2 are performed on a first UE 608a, a second UE 608b and third UE 608c. The steps in phase 3 may be performed by the first node 600 (e.g. the network node).

In phase 1, at step 602 a baseline autoencoder is trained on CSI data, in this example, the CSI database is a cloud-based dataset (CDS). In FIG. 6a the training is performed at a network vendor node to produce a baseline (BL) encoder 604 (BL-Enc-NW in FIG. 6a) and BL decoder 606 (BL-Dec-NW in FIG. 6b).

The skilled person will be familiar with training autoencoders, however a training tutorial is available from, for example TensorFlow, entitled “Intro to Autoecoders”. This is currently available at https://www.tensorflow.org/tutorials/generative/autoencoder. The baseline autoencoder may be trained in the known manner, using a training dataset of CSI data (e.g. from CDS).

To summarise, Phase-1 involves training a baseline (BL) encoder and decoder at NW or UE via a common cloud-based CSI dataset (CDS). After both BL encoder and decoder parts are trained using CDS, the decoder is sent to UEs, for individual training.

In phase 2, the Baseline decoder 606 BL-Dec-NW is sent to the first UE 608a, the second UE 608b and a third UE 608c. It will be appreciated that these are merely examples, and that the method may be extended to more than three UEs.

The first UE 608a then trains a second component model, which in this example is an encoder 610a, to encode data available at the first UE, in a manner that can be decoded by the baseline decoder, BL-Dec-NW 606. In the training in phase 2, the baseline decoder 606 is “frozen” in the sense that during the backpropagation phase, the weights and biases of the baseline decoder 606 are not updated in the training, only the weights and biases of the encoder 610a are updated.

Freezing prevents the weights of a neural network layer from being modified during the backward pass of training. You progressively ‘lock-in’ the weights for each layer to reduce the amount of computation in the backward pass and decrease training time. In the case of a frozen parameter, when doing the back propagation it's partial derivative is not computed, and as such it is “skipped”.

Note that, a horizontal layer can be unfrozen if it is decided to continue training—an example of this is transfer learning: start with a pre-trained model, unfreeze the weights, then continuing training on a different dataset.

In step 612a, a first data product is then sent to the first node 600. In this example, the first data product can be: option 1) the second component model e.g. encoder 610a, or option 2) a latent representation 614 of CSI data available at the third node, the latent representation 614 having been obtained by passing the CSI data through the second component model e.g. compressed CSI data output by the second component model.

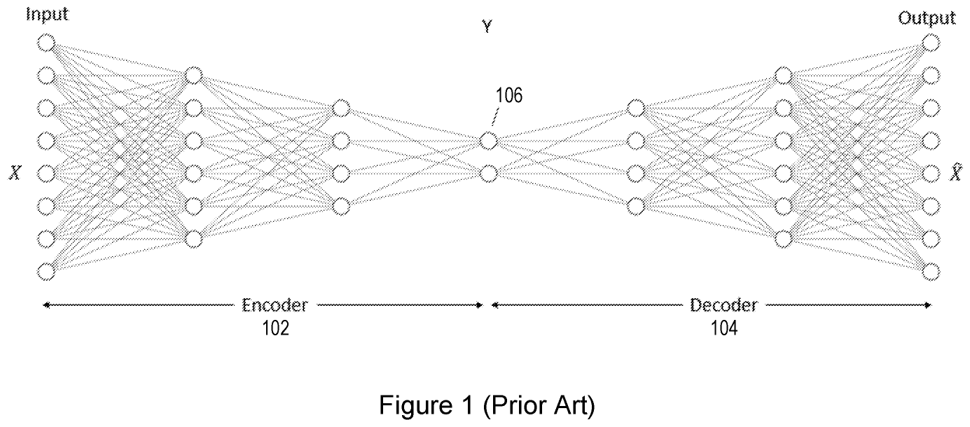

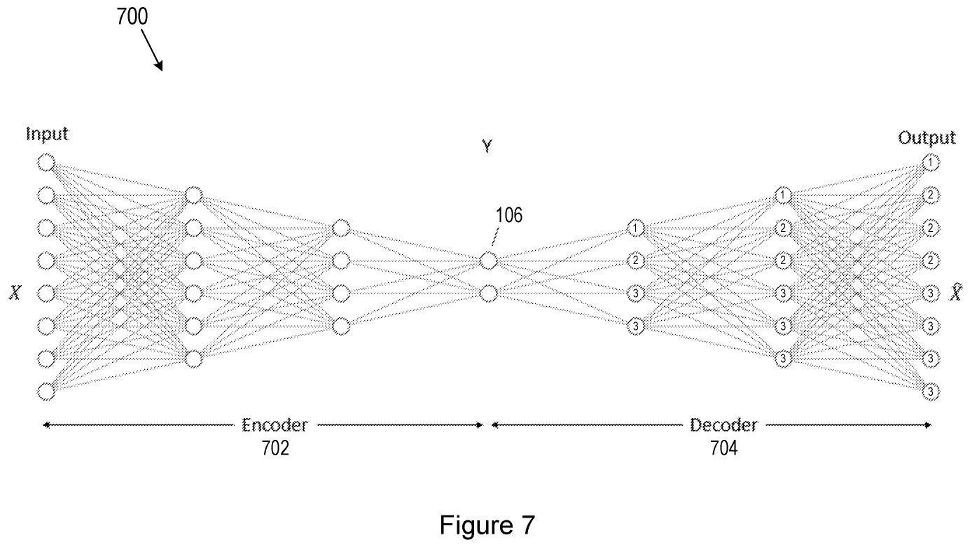

In option 1) the encoder 610a trained at the first UE is sent directly to the first node 600 (e.g. the network node). In option 2), outputs of the encoder 610a are sent to the first node 600, as noted above, the outputs are referred to herein as “latents”, latent representations of the CSI data available at the first UE. In other words, a latent representation of CSI data is a compressed version of said CSI data (e.g. the output of the encoder 610a when the CSI data is provided as input). The latent representation 614 is the output of neurons 106 in FIG. 1 and FIG. 7 e.g. the compressed version “Y”, of the input data “X”. Option 2) may be pursued, for example, in scenarios where for privacy reasons (or technical reasons such as a desire to reduce signalling overhead), it is undesirable for the first UE 608a to send the encoder 610a directly to the first node 600.

The second UE 608b performs equivalent steps to the first UE 608a in phase 2 and trains a third component model, encoder 610b, using CSI data available at the second UE, to compress the CSI data available at the second UE in a manner that can be decoded by the baseline decoder 606. The second UE 608b then sends in 612b an output of the training to the first node 600. As noted above, once trained, encoder 610b may be sent to the first node 600, or latent representations of CSI data available at the second UE may be sent to the first node 600, according to options 1) and 2), as described above.

The third UE 608c, also performs equivalent steps to the first UE 608a in phase 2 and trains a fourth component model, encoder 610c, using CSI data available at the third UE, to compress the CSI data available at the second UE in a manner that can be decoded by the baseline decoder 606. The third UE 608b then sends in 612c an output of the training to the first node 600. As noted above, once trained, encoder 610c may be sent to the first node 600, or latent representations of CSI data available at the second UE may be sent to the first node 600, according to options 1) and 2), as described above.

Thus, to summarise, Phase-2 is about training individual UE-vendor encoders at each UE side (on data available at the respective UE). In this example, each UE 608a, 608b, 608c uses its own dataset to train the encoder, given a frozen BL decoder sent from the first node 600 (NW). After the individual UE encoders are trained at UE side, they are sent to the first node 600 (which may be a gNB) for the actual BRIL training of universal decoder.

It will be appreciated that FIG. 6a is merely an example and that Phase 2 may performed in an equivalent manner by fourth and/or subsequent UEs, in the manner described above.

Phase-3 of FIG. 6a is performed by the first node (e.g. the network node). In Phase 3, the first node 600 performs steps 502 and 504 of the method 500 described above. In step 502 the first node trains the first component model using the first data product obtained from the second node. The training comprises freezing a first subset of horizontal layers in the first component model during a first backward pass training stage.

As used herein a horizontal layer refers to a route by which data can pass through the AE, from the input layer to the output layer. This is illustrated in FIG. 7 which illustrates an autoencoder 700, the autoencoder 700 comprises an Encoder 702 and a decoder 704. In this example, each circle represents a neuron (or graphical node) in the autoencoder. A horizontal layer is illustrated in FIG. 1 as the three graphical nodes labelled “1”. Put another way, a horizontal layer as defined herein is a sequence of graphical nodes through the decoder through which data can pass during a forward-pass through the network.

In the example of FIG. 7, the decoder 704 has been split into three subsets of horizontal layers, a first subset of horizontal layers labelled 1, a second subset of horizontal layers labelled 2 and a third subset of horizontal layers labelled 3 respectively. It will be appreciated that the three subsets indicated in FIG. 7 are merely an example and that an encoder or a decoder may comprise different numbers of horizontal layers to those illustrated in FIG. 7. Furthermore, the first subset of layers, the second subset of layers and the third subset of layers may comprise different numbers of horizontal layers to those illustrated in FIG. 7.

Turning back to Phase-3 of FIG. 6a, in step 502, a first subset of horizontal layers are frozen during a first backward pass training stage the training of the first component model using the first data product. The forward pass through the network proceeds as normal, but during the back propagation phase, the first subset of horizontal layers are frozen, or left unchanged.

In this sense, 1. Given a certain batch of inputs, multiplication of data with neurons happens in what is called FeedForward (FF) pass . . . .
2. The loss function, e.g. the output of that FF pass with respect to the groundtruth of labels is calculated.
3. Based on this loss, a backpropagation over all neurons happens:
   3.1 Neurons that are frozen are not affect
   3.2 Neurons that are unfrozen are updated based on the gradient of the loss with respect to the weights of the neuron.

Thus, in this manner, in the case of a frozen parameter, during back propagation its partial derivative is not computed, and as such it is “skipped”. Put another way, the loss function is agnostic to frozen/non frozen layers—it just considers the output. Frozen layers (or neurons) are there but they are not affected by the back propagation process. As such they contribute but they are never learned/updated. As such their value (or weight) remains constant and as such it has an influence on the loss.

As illustrated in FIG. 6a, the first subset of horizontal layers may comprise layers 616b and 616c. Thus, in the training of the first model using the first data product, only layers 616a may be updated during the backward pass through the network.

It is further noted that an input layer 616d and/or an output layer 616e may also be frozen in the training.

In option 1) described above where the first data product is the first component model (e.g. first encoder 610a as trained by the first UE 608a), the training proceeds by freezing the first encoder and the first subset of horizontal layers in the back propagation phase. In other words only the unfrozen layers 616a in the first component model (e.g. the decoder 606) are updated. Thus, the (remaining) unfrozen layers are trained to decode CSI data that was compressed by encoder 610a that was trained by the first UE on CSI data available at the first UE.

In scenario b) described above whereby the first data product is a latent 614 representation of CSI data available at the first UE 608a, the latent representations are fed to the decoder 606 as input and the decoder is trained to reconstruct the CSI data of each latent representation. As such, both the latent representation and the original CSI data may be sent to the first node in step 614a.

Following the training of the first component model using the first data product obtained from the first UE 608a, the process is repeated using the second data product from the second UE 608b, according to step 504 of the method 500 above. In step 504, a second subset of horizontal layers are frozen to the first subset of horizontal layers. For example, with respect to FIG. 6a, layers 616a and 616c may be frozen during the second backward pass stage. Layers 616b may be unfrozen and updated during the second backward pass. It will be appreciated however that the layers indicated in FIG. 6a are an example only and that other layers and/or other combinations of layers may be frozen in the second backward pass.

Following the training of the first component model using the second data product obtained from the second UE608b, the process may be repeated using data products from other UEs. For example, the training may be repeated for third UE 608c and/or subsequent UEs. For example, during the training of the first component model using a third data product from the third UE, a third subset of horizontal layers may be frozen during a third backward pass. The third subset of layers may be different to the first subset of horizontal layers and/or the second subset of horizontal layers. For example, with respect to FIG. 6a, layers 616a and 616b may be frozen during the third backward pass stage. Layers 616c may be unfrozen and updated during the third backward pass.

It will be appreciated however that the layers indicated in FIG. 6a are an example only and that other layers and/or other combinations of layers may be frozen in the second backward pass. As an example, the horizontal layers may be divided between the first subset of layers, the second subset of layers and/or the third and/or subsequent subsets of layers, according to the amount of CSI data available at each corresponding UE. For example, if the first UE 608a has more CSI data available than the second UE 608b, then more horizontal layers may be unfrozen in step 502 e.g. when training using the first data product, compared to step 504, e.g. when training using the second data product. As another example, the horizontal layers may be divided between the first subset of layers, the second subset of layers and/or the third and/or subsequent subsets of layers, according to the relative proportions of CSI data is exchanged between the first UE 608a and the first node, and the second UE 608b and the first node. For example, if the first UE 608a sends more compressed CSI data to the first node, compared to that sent by the second UE 608b to the first node, then more horizontal layers may be unfrozen in step 502 e.g. when training using the first data product, compared to step 504, e.g. when training using the second data product. It will be appreciated that these are merely examples however and that the layers may be partitioned between the first subset of horizontal layers, the second subset of horizontal layers and/or third and/or subsequent(s) of horizontal layers in any other manner, according to any other criteria to that described here.

It will further be appreciated that other layers may be frozen during the training. For example, in some embodiments, the input layer and/or the output layer may be frozen (e.g. frozen compared to the baseline version of the first component model.)

Put another way, Phase-3 is about the proposed Balanced Replay-buffer Incremental Learning that constructs the universal decoder. For this step, the following components may be considered: 1) individually trained UE Encoders (610a, 610b, 610c), 2) latent output per UE+common encoder, 3) multi-layer decoder 608a (each group of layers 616a, 616b, 616c-represents a virtual focus per UE vendor, in addition, input 616d and output 616e layers represent common learning). As described above, Phase 3 could be trained via two options:

Option-1 considers the case where all individual encoders and decoder are placed at the NW (e.g. UEs 608a, 608b, 608c send their encoders to the first node), and the input is taken from the common Channel Data Service (CDS). The UEs' encoders 610a, 610b 610c are frozen (non-trainable parameters) and not considered in the back-propagation stage of the training.

Option-2 considers the case where the encoders 610a, 610b 610c are not sent to the first node and stay at the UEs 608a, 608b, 608c. In this option, UEs 608a, 608b, 608c send their corresponding latent output (e.g. CSI data that has been compressed/output by one of the encoders 610a, 610b 610c) to the first node (e.g. to the NW), where the decoders are at NW. The input to the UE vendors is used from UE specific dataset. The UEs' encoders are frozen and not considered in the back-propagation stage of the training.

In both options, the first node (at the NW) incrementally trains the decoder by segmenting (e.g. splitting into groups or subsets of layers) its layers into multiple segments (layer-Segmenting) representing each UE vendor (with different shading on the figure: 616a for vendor A1, 616b for A2, 616c for A3, etc) and a common layer (616e). When training for a UE-vendor, its corresponding segment is unfrozen, whereas the other segments of other UE-vendors are frozen. The corresponding input to the decoder will be dependent on the group of layers that is trained in this step, if the group of layers represents vendor A1, then the majority of the latent data output is from the encoder 610a, whereas smaller segments of latent data are sampled from other UEs/common vendors (this is what we call Data-Segmenting and Latent-Segmenting). Upon iterating over the training per latent-Segment for all UE-vendors, the decoder is expected to converge to a stable loss value.

In addition to the segmentation of the layers of the first component model, the data used to train it may also be segmented.

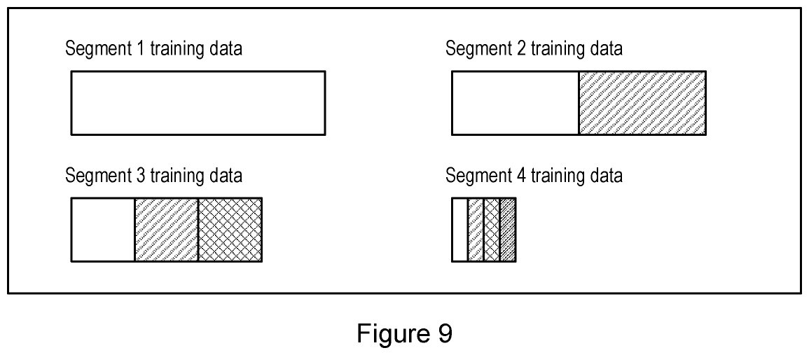

As an example, in one embodiment, the method 500 comprises segmenting the layers of the first component model and the CSI data (used to train it) into:
A NN segment (e.g. comprising a subset of layers) per each vendor (or group of vendors, depending on clustering algorithm proposed below, which uses similarities across their latent space). In other words, allocate the layers to different subsets of layers, according to vendor).
Per each iteration, split the CSI data or latents available for training (if option 2) described above is used so as to comprise the main chunk from current UE-vendor (or a group of vendors based on clustering from similarities of their latent samples), while including smaller chunks of data/latent from other vendors (and common) into current training of current vendor. This may be referred to as a “Balanced Replay-buffer” as the data used to train each subset of horizontal layers is selected to reflect the specific representation/distribution of data. This is illustrated in FIG. 9 which shows four options for how to put together a dataset comprising segments of CSI data for training purposes from different vendors (e.g. different UEs). Each segment represents data from a single vendor, and segments can have similar size, or have different lengths of segments. As an example, when performing the training in step 502, the data used for that step of training could be taken equally from the UEs 608a, 608b, 608c or a dataset could be compiled with different proportions of data from different individual sources. For example, the majority of the training data could be taken from the respective UE, with smaller proportions of data from other UEs. Or the data could be split proportionally to the number of CSI reports sent by each respective UE.

In this example, the method 500 may be written in pseudocode as follows:

Loop over all vendors
a. Initialize:
   i. Freeze
      1. The last layer of baseline decoder, which we call hereafterBRIL_Decoder_‘u’
         a. To solve the problem of having different input element per vendor
      2. The layers of the BL-Enc-UE, to maintain universality of the model
   ii. Layer and Latent Segmentation phase is conducted on BRIL_Dec_‘u’
      1. Freeze layers that don't belong to vendor ‘u’+Encrypting
      2. Split the Balanced Replay buffer of latent samples to consider the current vendor
b. Loop over epochs [conventional training]
   i. Loop over batches [conventional training]

In the pseudocode above, step 502 of the method 500 corresponds, for example, to the first iteration of the loop and step 504 corresponds to the second iteration of the loop.

Turning now to various methods for segmenting the data, in one example, a large percentage of the latent is segmented from the Encoder part belonging to a specific vendor, or BL encoder. Here we identify a couple of methods that could be used to identifying the value of the percentage of latent-Segmentation per vendor in each iteration. Assuming that there is a loop over all vendors, and within each iteration a single vendor is targeted, referred to in this example as the Target-Vendor.

### Prioritized Per Target-Vendor Approach:

In this approach, the percentage of each latent-segment per vendor is calculated using two components:

Normalized Difference in latent sample size between target-Vendor (tv) latent sample size and the minimum sampled vendor, let's call the normalized output of this difference as Lat_{diff}(tv)∈[0,1]. Zero value means that target-vendor latent size is the minimum sampled vendor.

Aggregated or average difference in (normalized) Kullback-Leibler (KL) divergence between target-Vendor (tv) latent space and all other vendors' latent spaces, let's denote this as Lat_{KL}(tv)∈[0,1].

The percentage of size of target-vendor latent-segment (call it: %_{STV}) would be a function of:

$${\%}_{STV \_ tv} = \{ \frac{1}{V} + {w}_{diff} ( 1 - L a {t}_{diff} ( tv ) ) + \frac{{w}_{KL}}{{Lat}_{KL} ( tv )} \} / {STV}_{norm} -$$

Where v is number of vendors, w_{diff} and w_{KL} are weighting scales that give less or more value to each component, the normalized difference in latent space size, and the average KL divergence, respectively. The STVₙₒᵣₘ is the normalized value of STV. STVₙₒᵣₘ can be found via plugging the min or max parameters in the original equation, as follows:

$${STV}_{Norm} = \frac{1}{V\_min} + {w}_{diff} ( 1 - {Lat}_{min} ( tv ) ) + \frac{{w}_{KL}}{L a {t}_{min} ( tv )}$$

### Uniform Approach:

This is simply having the same percentage for all vendors (target and others), hence:

$${\%}_{STV \_ tv} = \frac{1}{V}$$

Thus, in the manner described above, the method 400 may be used to obtain a global first component model (either an encoder or decoder). Freezing of different layers so that an algorithm updates different parts of a General Adversarial Network (GAN) during training on different datasets is described in the thesis by Jón Rúnar Baldvinsson entitled “Rare Event Learning in URLLC Wireless Networking Environment Using GANs” (2021). It has been recognised by the Inventors herein that the techniques described therein may be applied equally to the training of an Autoencoder in order to compress and decompress CSI data.

In order to address the privacy aspects of having a malicious vendor sending corrupted data or a corrupted encoder to NW, the following steps may be performed:
Avoid UE-localized training of Decoder, hence the impact of malicious UE would be only on encoder or input data
Use input data (to vendor-freezed encoder) only from CDS (i.e., updated and test dataset frequently). With this the only possibility to be harmed from malicious UE is to send a corrupted Encoder, which can be avoided via:
Training the decoder at gNB and freezing the malicious encoders,
Adding a term to the %_{STV_tv} to reduce the latent samples produced via the malicious encoder, hence it becomes:

$${\%}_{STV \_ tv} = max \{ \frac{\frac{1}{V} + {w}_{diff} ( 1 - L a {t}_{diff} ( tv ) ) + \frac{{w}_{KL}}{{Lat}_{KL} ( tv )} - {Ven}_{iTr} ( tv )}{STV\_Norm} , 0 \} ,$$

### Where,

$${STV}_{Norm} = \frac{1}{V\_min} + {w}_{diff} ( 1 - {Lat}_{min} ( tv ) ) + \frac{{w}_{KL}}{L a {t}_{min} ( tv )} - {Ven}_{min} ( tv )$$

where Ven_{iTr}(tv) is a factor that measures the level of untrust between gNB and this specific tv vendor which the current latent samples are produced from its encoder. The more the gNB trusts the vendor, the lower this term is, and the less gNB trusts this vendor the higher Ven_{iTr}(tv) will be.

We note that the above process is applied when a trust level between gNB and UE vendor is established. Depending on this trust level (called Ven_{iTr}(tv)), we calculate a ratio (STV_{Norm}) which is used to filter out a certain percentage of the UE, which has limited trust level. So, in short, identify trust level between NW and UE vendor is not within the scope of this invention, but it is assumed to have been already obtained.

Training the decoder using the method 500 preserves the learning obtained on each dataset (e.g. the learning from the first UE, the second UE and the third UE) and prevents the phenomenon of “catastrophic forgetting” whereby previous learnings are effectively overwritten by subsequent learnings. This creates a balance between the learnings obtained from each UE. It further allows the model to learn and retain knowledge from rare events or slight differences between CSI data available at the first UE, the second UE and the third UE. It has further been appreciated that this method can be applied to CSI data because the distributions of CSI datasets are similar enough between different UEs to allow for convergence. In summary, the freezing process described herein enables training of a single, “global” decoder that is fine tuned to accurately decode compressed CSI output from three different encoders that were trained to compress CSI based on three different datasets.

FIG. 6b illustrates the trained model in use. Following training, the decoder 608c (e.g. the first component) output from the training process can be used to decode compressed CSI from encoders 610a, 610b or 610c.

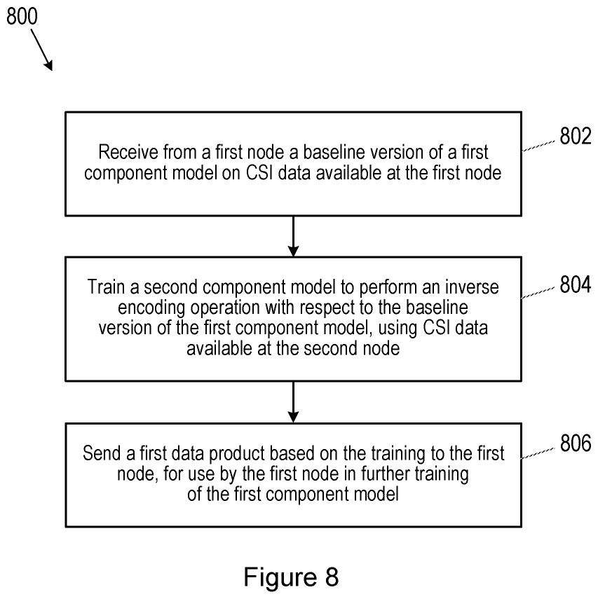

The first UE may perform reciprocal processes to the first node. For example, FIG. 8 shows a computer implemented method in a second node in a communications network for training a first component model of an Autoencoder, AE, machine learning model, the first component model being either an encoder or a decoder and wherein the first component model is for use in exchanging compressed Channel State Information (CSI) between the first node, a second node, and a third node in the communications network. In a first step 802, the method comprises receiving from a first node a baseline version of a first component model on CSI data available at the first node. In a second step 804 the method comprises training a second component model to perform a complementary (e.g. inverse) encoding operation with respect to the baseline version of the first component model, using CSI data available at the second node. In a third step the method comprises sending a first data product based on the training to the first node, for use by the first node in further training of the first component model.

As described above with respect to FIG. 5 and the method 500, the first data product may comprise one or more of the following: the second component model; and a latent representation of the CSI data available at the second node, the latent representation having been obtained by passing the CSI data through the second component model. Thus in the embodiment described with respect to FIG. 6, the method may comprise the second node sending an encoder (trained in opposition to the baseline decoder on data available at the second node). Alternatively or additionally, the second node may send a compressed representation of data that has passed through such an encoder.

More generally, the second component model will be an encoder if the first component model is a decoder, and a decoder if the first component model is an encoder. In other words, the second component model will be the opposite half (or inverse half) of a full encoder to the first component model.

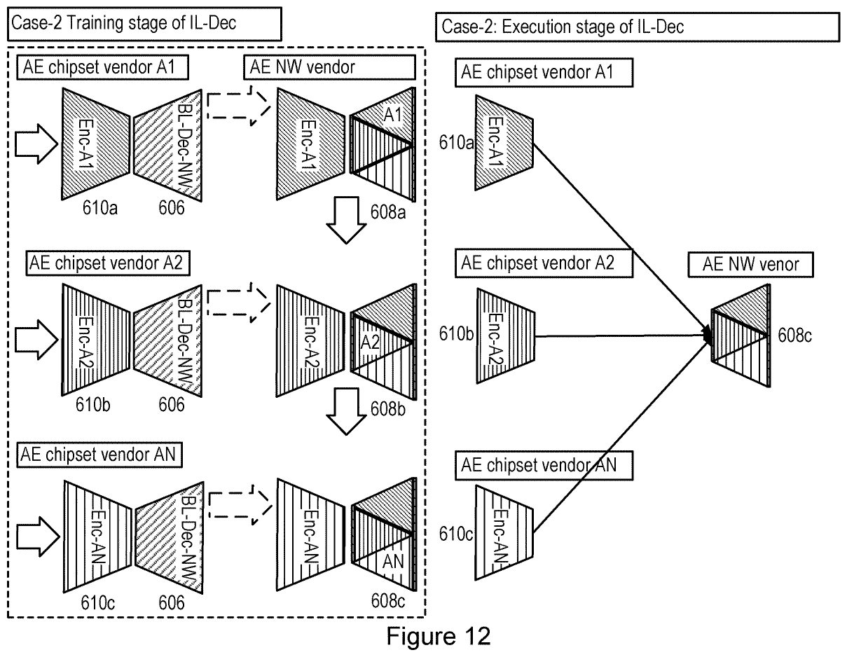

In some embodiments, as shown in the embodiment in FIG. 6, the first node is a first network node, the second node is a first user equipment, UE, and the third node is a second UE. As noted above, in this example, the first component model is a universal decoder for use by the first network node in decoding compressed CSI information from either the first UE or the second UE. This corresponds to Case-2 (box 412) in FIG. 4, and is also summarised in FIG. 12.

In use, the second component model may compress new CSI data using the second component model and send the new compressed CSI data to the first network node.

This execution stage (scenario-2 in FIG. 6b) of BRIL occurs when a UE vendor sends its latent channel to the BRIL universal decoder at gNB for decoding.

It will be appreciated that second and subsequent nodes may all perform the method 800 and send data products to the first node for use by the first node in training the first component model according to the method 500.

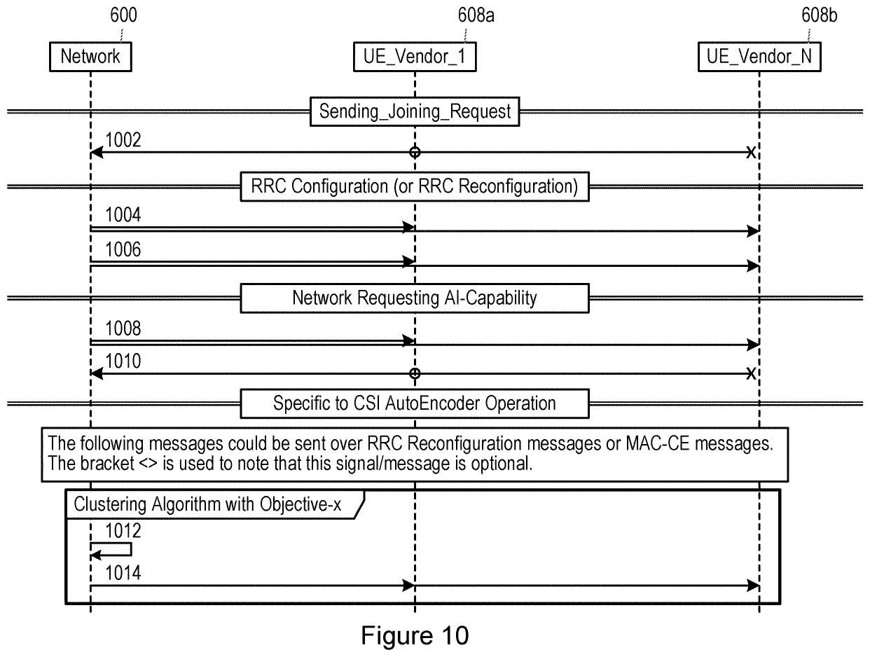

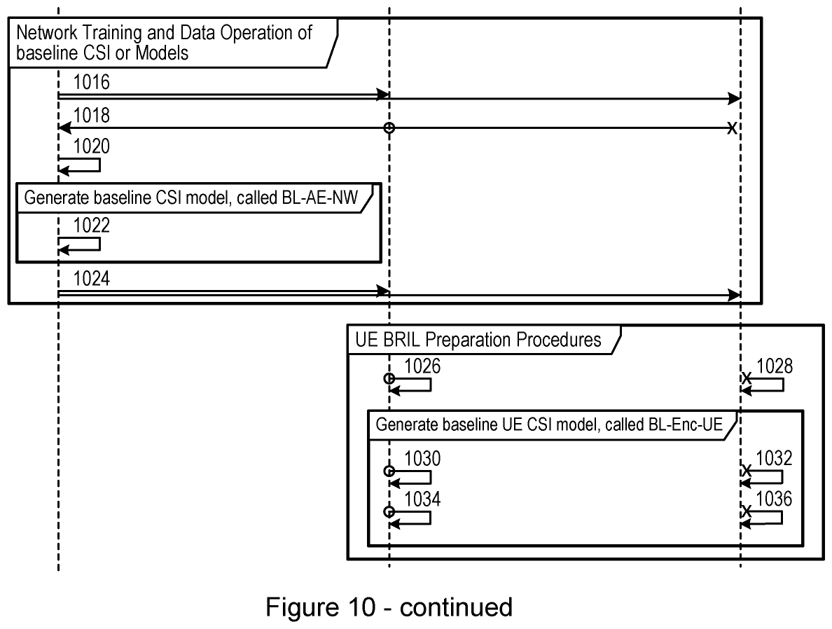

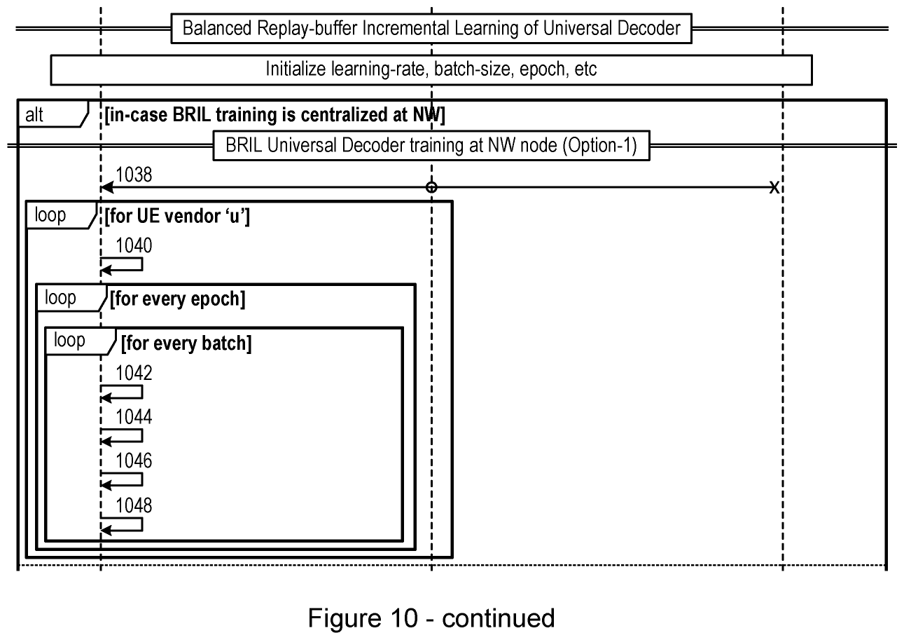

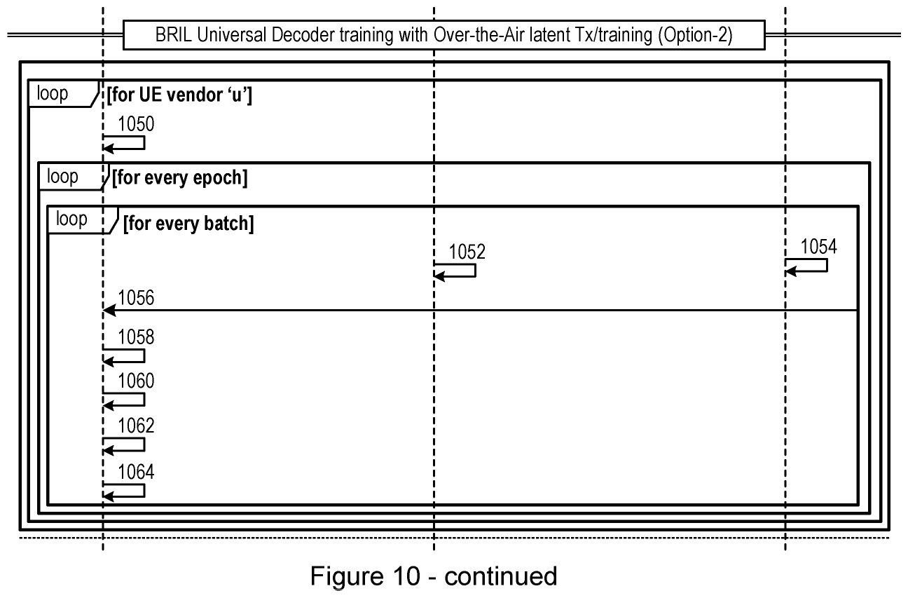

Turning now to FIG. 10 which shows a signal diagram describing BRIL for developing a universal Decoder for Multi-Chipset vendors and single network vendor between the different nodes in the embodiment in FIG. 6a. The signals in FIG. 10 are as follows:
1002: Vendors requesting to join the network, either first time, or rejoining: UEs 608a, 6-8b from different vendors (1 to N) join the network.
1004: Configure UEs with CSI-MeasConfig: Network node configures all UEs with CSI-MeasConfig (via RRCConfiguration, and/or RRCReconfiguration).
1006: Configure UEs with CSI-ReportConfig: Network node configures all UEs with CSI-ReportConfig (via RRCConfiguration, and/or RRCReconfiguration).
1008: Request UE-Vendors to send AI-Capabilities, including abilities to support AI related processes: Network request UEs AI-Capabilities (related to general AI and specific to CSI-compression), e.g., processing, ML model, and data quality capability.
1010: Report of AI and data information e.g. (processing, CPU, energy, Data-bias, drift, etc): UEs responds to network, with its computation capabilities and data quality

Some operations are related to network training and data operation off baseline CSI and/or models. Note that any of the following messages could be sent over RRC Reconfiguration messages or MAC-CE messages. In the sequence diagram, the bracket < > is used to denote that this signal/message or operation is optional.
1012: Clustering UEs to groups based on sent AI/Data capability set by UEs vendors: Network runs a clustering algorithm to find the UE vendors that are suitable to be trained together in a universal AE. For instance, some requirements that makes UE vendors within the same cluster is the distance between their CSI distributions.
1014: Message ID of UEs within cluster: The network messages to UE nodes, that belong to different vendors, all IDs of vendors within the same incremental learning cluster

### Operations Related to Network Training and Data Processing of CSI AE Baselines

1016: Requesting CSI or Synthetic parameter and/or trained baseline model: <The network requests from UEs CSI or Synthetics CSI parameter and/or trained baseline>
1018: Respond to network with requested CSI data: <The UE Vendors respond to Network with requested CSI data>
1020: Store all data from UE or existing in CDS (Common Cloud for CSI Dataset): Store all dataset from UE or exists in CDS (Common Cloud for CSI Dataset).

### Operations Related to Generate Baseline CSI Model, Called BL-AE-NW

1022: Pseudocode for BP to train BL-AE-NW: The network runs a backpropagation to train BL-AE-NW (pseudo-code of backpropagation)
1024: Send generated baseline model (BL-Dec-NW): The Network sends to all UEs vendors the generated baseline model (BL-Dec-NW)

### Operations Related to Incremental Learning Preparation Procedures

1026/1028: The UE (belongs to different vendors)
1. Receives:
1.a <Receives Group or clusters of vendors>
1.b. <Receives/send trained baseline BL-Dec-NW>
2. <Discovers neighbor UE vendors>,
3. <Project/align shared baseline data or model into existing model or local data>.

### Generate Baseline UE CSI Model, Called BL-Enc-UE

1030/1032: Using agreed-On Data (either specific UE vendor, or CDS) and BL-Dec-NW (freezed) to trin BL-Enc-UE: UE Vendor uses Agreed-On Data (either from specific UE vendor or CDS) and BL-Dec-NW (freezed) to train BL-Enc-UE.
1034/1036: Pseudocode for BP to train BL-Enc-UE: UE runs a BP to train BL-Enc-UE (Pseudo-Code of backpropagation)
   Operations related to Incremental Learning of Universal Decoder
Initialize learning-rate, batch-size, epoch, etc

Option-1: If the target case is BRIL Universal Decoder training is at NW node.
1038: Message BL-Enc-UE: The UE Vendor sends to Network a message including BL-Enc-UE.
1040: loop over UE vendors ‘u’
The Network initializes:
   BRIL_Enc=BL-Enc of UE-Vendor ‘u’ (and freeze it)
   Freeze first & last layer of BL_Dec_‘u’_NW
   BRIL_Dec_‘u’=BL_Dec_‘u’_NW
   Layer-Segmentation phase is conducted on BRIL_Dec_‘u’
   BRIL_Dec=BRIL_Dec_‘u’ while freezing all other parts that are not selected via Layer-segmentation phase.
   Data-Segmentation process (i.e., Balanced Replay buffer) is applied to consider the current vendor latent as majority of training data, in addition to small parts of other vendor and common latent space.
loop over every epoch
   Loop over every batch
      1042 The network runs a FeedForward pass to compute y=f(BRIL_Enc+BRIL_Dec)=f(BRIL_AE)
      1044: Calculate reconstruction loss |y′−y| of AE_‘u’: The network calculates the reconstruction loss |y′−y| of AE_‘u’
      1046: Calculate backpropagation across all BRIL_Enc and BRIL_Dec except for last layer of BL_Dec and all non-‘u’ vendors parts: The network calculates backpropagation across all BRIL_Enc and BRIL_Dec except for last layer of BL_Dec and all non-‘u’ vendors parts.
      1048: Update unfrozen weights: The network updates all weights (except the frozen one)

Option-2: if the case is Incremental Learning of Universal Decoder Over-the-Air
Loop over every UE vendor ‘u’
   1050: The network initializes:
   a. Out_BRIL_Enc=transmission of output of BL-Enc of Vendor ‘u’
   b. Freeze first & last layer of BL_Dec_‘u’_NW
   c. Implicit freeze of BL-Enc-‘u’ as there is no transmission of gradient back to UE
   d. BRIL_Dec_‘u’=BL_Dec_‘u’_NW
   e. Layer-Segmentation phase is conducted on BRIL_Dec_‘u’
   f. Data-Segmentation process (i.e., Balanced Replay buffer) is applied to consider the current vendor latent as majority of training data, in addition to small parts of other vendor and common latent space.
   g. BRIL_Dec=BRIL_Dec_‘u’ while freezing all other parts that are not selected via Layer-Segmentation phase.
Loop over every epoch
   Loop over every batch
      1052 and 1054: The UE vendor runs a FeedForward pass to compute y_latent=f (BRIL_Enc)
      1056: The UE vendor sends to network a Message with y_latent
      1058: The network runs a FeedForward pass to compute y=f(BRIL_Enc(y_enc))
      1060: The network calculates the reconstruction loss |y′−y| of AE_‘u’
      1062: The network calculates backpropagation across all BRIL_Dec except for last layer of BL_Dec and all non-‘u’ vendors parts.
      1064: No backpropagation across BRIL_Enc, i.e. No Messaging of gradients of weights to UEs

FIG. 6a describes a training process for a universal decoder, however, an equivalent process could also be applied to the training of a universal encoder.

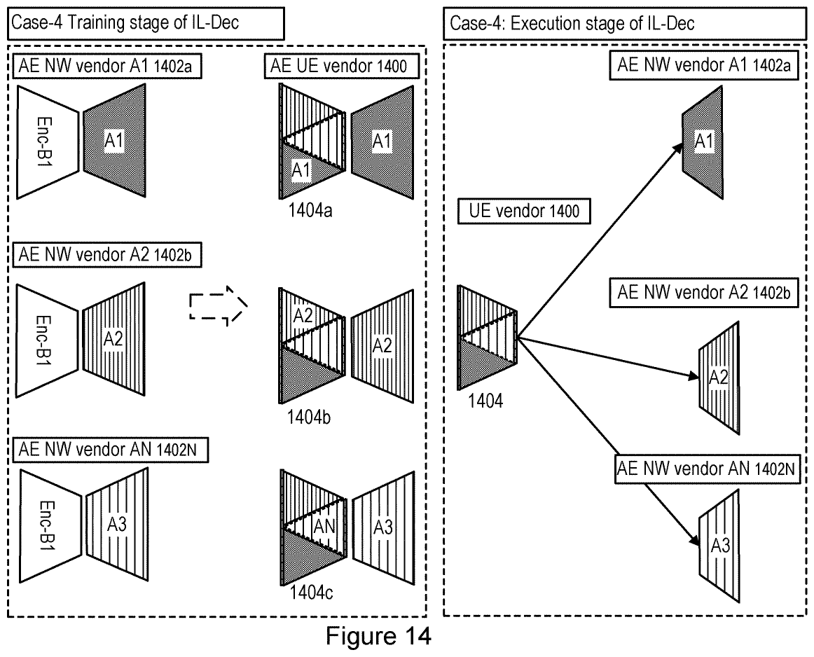

Such an embodiment is illustrated in FIG. 14 and corresponds to Case-4 (box 422) in FIG. 4. In the embodiment in FIG. 14, the first node is a first user equipment, UE 1400, the second node is a first network node 1402a, the third node is a second network node 1402b and the first component model 1404 is a universal encoder for use by the first user equipment 1400 in encoding CSI information that can be decoded by either the first network node 1402a or the second network node 1402b.

In use (the Execution stage in FIG. 14) the UE 1400 uses the trained first component model (universal encoder) 1400 to encode CSI that can be decoded by each of the respective decoders on network nodes 1402a, 1402b.

Turning now to other embodiments, the above embodiments describe the proposed process when the UE vendor agrees to exchange AI related signaling (standardization approach). However, this invention could stand alone, as a proprietary solution, though this could compromise the quality of the algorithm performance but still possible. To reach a stand-alone behavior of the proposed algorithm, the following changes may be made to the process above, as follows (reflected in FIG. 2):
1. In Phase-1, instead of sending the BL-Decoder from NW to UEs, we allow UEs to train its own decoder, hence now signaling is needed.
2. In phase-3, instead of requesting UEs to send their trained encoders to NW, and use it to locally generate latent space per vendor, in this embodiment, the CSI latent space may be sent by each vender to train the NW BRIL decoder. Although this step may involve sending CSI latent, there is not extra signaling needed.

Thus, in this embodiment, with respect to FIG. 6a, the first component model is passed between the different UE nodes for training against the encoders of the respective UEs.

In some embodiments of the method 500, the first data product received from the second node comprises a baseline version of the first component model that has been trained by the second node on CSI data available at the second node. In other words, the second node performs step 502 and forwards the resulting partially trained model to the first node.

The first node then trains a second component model to perform an inverse (e.g. opposite or complementary) encoding operation with respect to the baseline version of the first component model, using CSI data available at the second node. In this sense an inverse encoding operation or complementary encoding operation is e.g. a decoding operation if the first component model is an encoder or an encoding operation if the first component model is a decoder. In the embodiment of FIG. 6a, this results in Encoder 610a,610b and 610c. The method then comprises using the second component model in opposition to the first component model, in order to train the first component model in step i). The training in step i) may take place on the baseline version of the first model if this is the first iteration of the training. In other words, the method 500 may further comprise using the baseline version of the first component model as the starting point for the first component model in the training in step i).

Thus in summary, after having trained the second component model against the baseline component model, the baseline component model is then re-trained by the first node itself, on the CSI data at the first node, freezing the first subset of layers as described above. The training may be performed using CSI data available at the first node.

The first node then initiates the further training in step ii). In this embodiment, step ii) comprises sending one or more of the following to the third node to initiate the further training on the third node: i) the first component model as output from step i); ii) one or more parameters of the first component model as output from step i); or iii) one or more instructions to cause the third node to perform the further training.

The third node will then repeat the method 500 as described above. From the perspective of the third node performing the method 500, first node sends a data product comprising a first version of the first component model, the first version of the component model having been trained by the first node on CSI data available on the second node, by freezing the first subset of horizontal layers in the first component model during the first backward pass training stage, the method then comprises using the first version of the first component model as the starting point for the first component model in the training in step i).

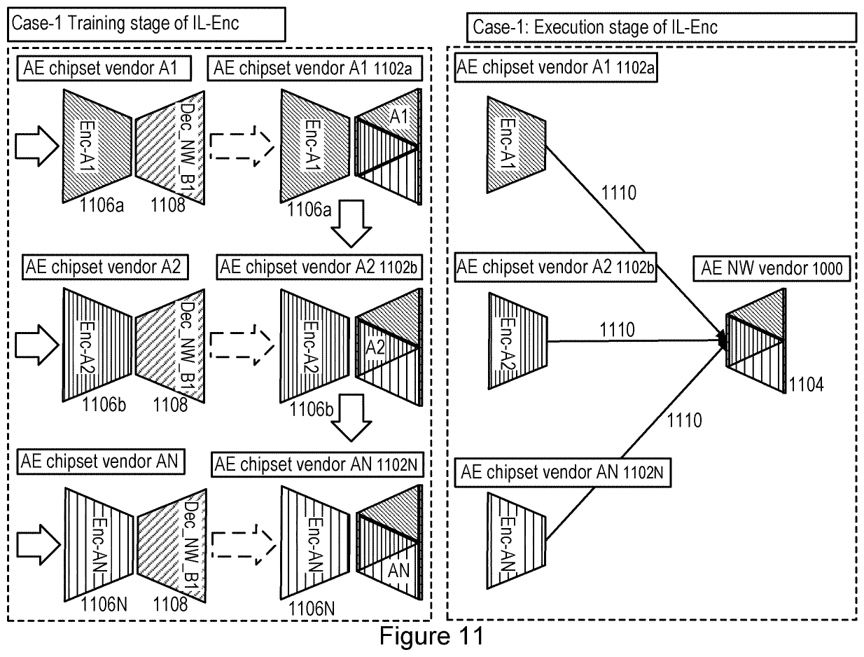

In one example, as illustrated in FIG. 11, the first node is a first user equipment, UE, 1102a, the second node is a first network node 1100, the third node is a second UE 1102b, and wherein the first component model is a universal decoder 1104 for use by the first network node 1000 in decoding compressed CSI information from either the first UE 1102a or the second UE 1102b (and any other UEs 1102N). In this embodiment, the second component model is encoder 1106a and this is trained against is trained against the baseline version of the first component model 1108 in the training stage.

In use (execution stage in FIG. 11), the method 500 may further comprise: sending the first component model to the first network node for use in decoding compressed CSI data from the first UE and/or the second UE. The method may further comprise compressing first CSI data, and sending (shown as arrows 1110 in FIG. 11) the compressed first CSI data to the first network node for decompression by the first component model. It is noted that FIG. 11 corresponds to Case-1 (box 406 in FIG. 4).

FIG. 12 shows a summary of Case-2 (box 412) in FIG. 4. This was described above with respect to FIGS. 6a and 6b and is provided in FIG. 12 for reference and comparison to FIGS. 11, 13 and 14.

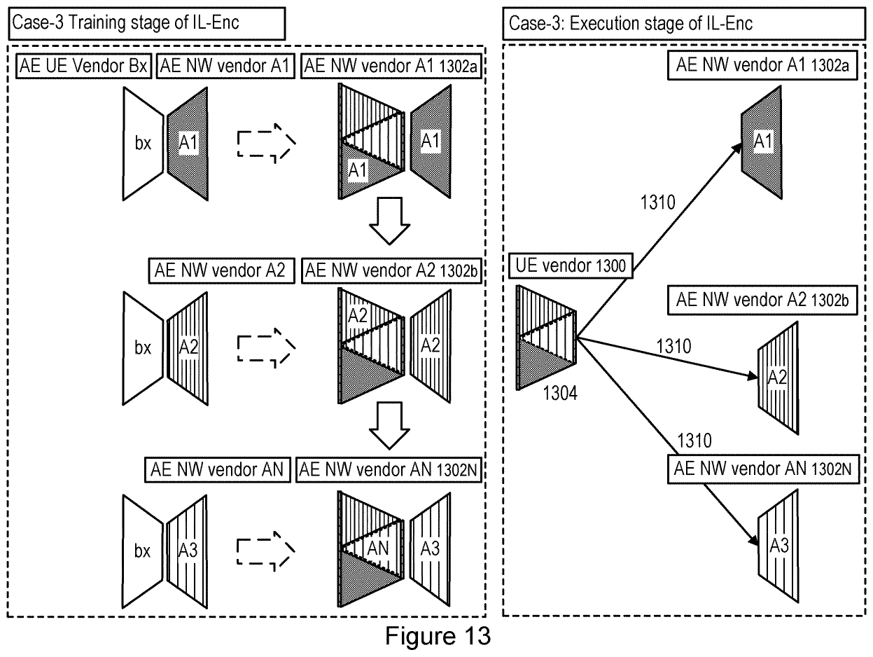

In another example, as illustrated in FIG. 13, the first node is a first network node 1302a, the second node is a first user equipment, UE 1300, the third node is a second network node 1302b, and the first component model is a universal encoder 1304 for use by the first UE 1300 in encoding CSI information that can be decoded by either the first network node 1302a or the second network node 1302b (and any other network nodes 1302N). In use (execution stage in FIG. 13), the method may thus further comprise compressing first CSI data using the first component model, and sending (shown as arrows 1310 in FIG. 13) the compressed first CSI data to the first network node and/or the second network node e.g. for decompression by respective decoders trained on data at each of the first, second and/or subsequent nodes respectively. It is noted that FIG. 13 corresponds to Case-3 (box 418 in FIG. 4). In another embodiment, there is provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### APPENDIX I

TABLE 1

| | | | | | (‘L3rsrp’, | (‘L3rsrp’, |
|---|---|---|---|---|---|---|
| | | | | | 0, 0, | 0, 0, |
| Time_round | Feature | Iteration | Seed | userId | 10013) | 10014) |
| 0.013 | 0 | 0 | 6009 | 0 | −103.057 | −66.5432 |
| 0.013 | 0 | 0 | 6009 | 1 | −115.648 | −97.2135 |
| 0.013 | 0 | 0 | 6009 | 2 | −107.306 | −123.947 |
| 0.013 | 0 | 0 | 6009 | 3 | −120.706 | −128.729 |
| 0.013 | 0 | 0 | 6009 | 4 | −115.407 | −123.549 |
| 0.013 | 0 | 0 | 6009 | 5 | −112.1 | −120.268 |

| (‘L3rsrp’, | (‘L3rsrp’, | (‘L3rsrp’, | (‘L3rsrp’, | (‘L3rsrp’, | (‘L3rsrp’, | (‘L3rsrp’, |
|---|---|---|---|---|---|---|
| 0, 0, | 0, 2, | 0, 4, | 0, 4, | 0, 4, | 0, 4, | 0, 4, |
| 10015) | 30010) | 50000) | 50001) | 50003) | 50004) | 50005) |
| −100.3432 | −115.741 | −124.785 | −116.404 | −124.186 | −125.631 | −130.709 |
| −111.833 | −119.297 | −135.307 | −116.348 | −124.557 | −113.599 | −119.686 |
| −104.008 | −112.017 | −116.431 | −114.479 | −111.054 | −117.604 | −121.85 |
| −120.97 | −120.809 | −92.458 | −88.4291 | −93.271 | −119.923 | −121.066 |
| −83.9676 | −124.009 | −116.275 | −89.9976 | −104.964 | −112.501 | −115.054 |
| −110.736 | −118.504 | −112.262 | −122.182 | −122.551 | −111.241 | −122.459 |

| (‘L3rsrp’, | (‘L3rsrp’, | (‘L3rsrp’, | (‘L3rsrp’, | (‘L3rsrp’, | (‘L3rsrp’, | (‘L3rsrp’, |
|---|---|---|---|---|---|---|
| 0, 4, | 0, 6, | 0, 6, | 0, 6, | 0, 6, | 0, 6, | 0, 6, |
| 50002) | 40011) | 40008) | 40007) | 40015) | 40005) | 40006) |
| −104.068 | −76.8118 | −100.4665 | −124.038 | −124.783 | −115.848 | −125.249 |
| −85.5112 | −121.111 | −113.235 | −133.307 | −112.771 | −122.716 | −117.542 |
| −108.609 | −121.245 | −132.615 | −125.911 | −117.887 | −123.243 | −131.453 |
| −107.497 | −90.4642 | −85.3396 | −92.1297 | −116.57 | −132.236 | −104.454 |
| −122.776 | −77.7172 | −123.618 | −123.793 | −117975 | −122.91 | −76.7108 |
| −116.466 | −123.745 | −116.766 | −95.7323 | −94.9788 | −119.198 | −112.029 |

| (‘L3rsrp’, | (‘L3rsrp’, |
|---|---|
| 0, 6, | 0, 6, |
| 40004) | 40009) |
| −125.647 | −125.345 |
| −131.85 | −121.893 |
| −124.805 | −113.214 |
| −113.399 | −122.755 |
| −126.538 | −121.632 |
| −119.55 | −114.898 |

1. A computer-implemented method in a first node in a communications network for training a first component model of an Autoencoder (AE) machine learning model, the first component model being either an encoder or a decoder and wherein the first component model is for use in exchanging compressed channel state information (CSI) between the first node, a second node, and a third node in the communications network, the method comprising:
i) training the first component model using a first data product obtained from the second node, wherein the training comprises freezing a first subset of horizontal layers in the first component model during a first backward pass training stage; and
ii) initiating further training of the first component model using a second data product from the third node, wherein the further training comprises freezing a second subset of horizontal layers in the first component model during a second backward pass training stage, the first subset of horizontal layers being different to the second subset of horizontal layers.

2. The method of claim 1, wherein preceding steps i) and ii) the method further comprises:
training a baseline version of the first component model on first CSI data; and wherein:
the training in step i) is performed on the baseline version of the first component model.

3. The method of claim 2, further comprising sending the baseline version of the first component model to both the second node and the third node.

4. The method of claim 3, further comprising:
receiving the first data product from the second node, the first data product having been obtained as a result of the second node training a second component model to perform a complementary encoding operation with respect to the baseline version of the first component model, using CSI data available at the second node.

5. The method of claim 3, further comprising:
receiving the second data product from the third node, the second data product having been obtained as a result of the third node training a third component model to perform a complementary encoding operation with respect to the baseline version of the first component model, using CSI data available at the third node.

6. The method of claim 4, wherein the first data product is the second component model and/or the second data product is the third component model.

7. The method of claim 4, wherein step i) comprises using the first component model and the second component model in opposition to one another during the training.

8. The method of claim 4, wherein the first data product comprises a latent representation of the CSI data available at the second node, the latent representation having been obtained by passing the CSI data through the second component model; and/or
wherein the second data product comprises a latent representation of the CSI data available at the third node, the latent representation having been obtained by passing the CSI data through the second component model.

9. The method of claim 8, wherein in step i) the first component model is trained to:
decompress the latent representation available at the second or third node if the first component model is a decoder; or
compress the CSI data available at the third node to produce the latent representation, if the first component model is an encoder.

10. The method of claim 4, wherein the second component model is an encoder if the first component model is a decoder, and a decoder if the first component model is an encoder; and wherein
the third component model is an encoder if the first component model is a decoder and a decoder if the first component model is an encoder.

11. The method of claim 1, wherein the further training is performed by the first node.

12. The method of claim 1, wherein the first node is a first network node, the second node is a first user equipment, UE, the third node is a second UE; and wherein the first component model is a universal decoder for use by the first network node in decoding compressed CSI information from either the first UE or the second UE.

13. The method of claim 12, further comprising:
receiving first compressed CSI data from the first UE, and decompressing the first compressed CSI data, using the first component model; and/or
receiving second compressed CSI data from the first UE, and decompressing the second compressed CSI data, using the first component model.

14. The method of claim 1, wherein
the first node is a first user equipment, UE,
the second node is a first network node,
the third node is a second network node,
the first component model is a universal encoder for use by the first user equipment in encoding CSI information that can be decoded by either the first network node or the second network node, and
the method further comprises:
compressing first CSI data to obtain compressed first CSI data, using the first component model; and
sending the compressed first CSI data to the first network node and/or the second network node.

15. (canceled)

16. The method of claim 1, wherein the first data product comprises a baseline version of the first component model that has been trained by the second node on CSI data available at the second node; and wherein the method further comprises:
training a second component model to perform a complementary encoding operation with respect to the baseline version of the first component model, using CSI data available at the second node; and
using the second component model in opposition to the first component model, in order to train the first component model in step i).

17. (canceled)

18. The method of claim 16, wherein the first data product further comprises a first version of the first component model, the first version of the component model having been trained by the second node on CSI data available on the second node, by freezing a third subset of horizontal layers in the first component model during a third backward pass training stage, the third subset of horizontal layers being different to the first subset of horizontal layers and the second subset of horizontal layers; and
using the first version of the first component model as the starting point for the first component model in the training in step i).

19. (canceled)

20. The method of claim 16, wherein step ii) comprises sending one or more of the following to the third node to initiate the further training on the third node:
i) the first component model as output from step i);
ii) one or more parameters of the first component model as output from step i);
iii) one or more instructions to cause the third node to perform the further training.

21. (canceled)

22. The method of claim 16, wherein
the first node is a first user equipment, UE,
the second node is a first network node,
the third node is a second UE,
the first component model is a universal decoder for use by the first network node in decoding compressed CSI information from either the first UE or the second UE, and
the method further comprises:
sending the first component model to the first network node for use in decoding compressed CSI data from the first UE and/or the second UE;
compressing first CSI data; and
sending the compressed first CSI data to the first network node.

23-24. (canceled)

25. The method of claim 16, wherein
the first node is a first network node,
the second node is a first user equipment, UE,
the third node is a second network node,
the first component model is a universal encoder for use by the first UE in encoding CSI information that can be decoded by either the first network node or the second network node, and
the method further comprises:
compressing first CSI data using the first component model; and
sending the compressed first CSI data to the first network node and/or the second network node.

26. (canceled)

27. A computer implemented method in a second node in a communications network for training a first component model of an Autoencoder (AE) machine learning model, the first component model being either an encoder or a decoder and wherein the first component model is for use in exchanging compressed channel state information (CSI) between the first node, a second node, and a third node in the communications network, the method comprising:
receiving from a first node a baseline version of a first component model on CSI data available at the first node;
training a second component model to perform a complementary encoding operation with respect to the baseline version of the first component model, using CSI data available at the second node; and
sending a first data product based on the training to the first node, for use by the first node in further training of the first component model.

28. The method of claim 27, wherein first data product comprises one or more of the following:
the second component model; and
a latent representation of the CSI data available at the second node, the latent representation having been obtained by passing the CSI data through the second component model.

29. The method of claim 27, wherein the second component model is an encoder if the first component model is a decoder, and a decoder if the first component model is an encoder.

30-33. (canceled)

34. A first node in a communications network for training a first component model of an Autoencoder (AE) machine learning model, the first component model being either an encoder or a decoder and wherein the first component model is for use in exchanging compressed channel state information (CSI) between the first node, a second node, and a third node in the communications network, the first node comprising:
a memory comprising instruction data representing a set of instructions; and
a processor configured to communicate with the memory and to execute the set of instructions, wherein the first node is configured to:
i) train the first component model using a first data product obtained from the second node, wherein the training comprises freezing a first subset of horizontal layers in the first component model during a first backward pass training stage; and
ii) initiate further training of the first component model using a second data product from the third node, wherein the further training comprises freezing a second subset of horizontal layers in the first component model during a second backward pass training stage, the first subset of horizontal layers being different to the second subset of horizontal layers.

35-37. (canceled)

38. A second node in a communications network for training a first component model of an Autoencoder (AE) machine learning model, the first component model being either an encoder or a decoder and wherein the first component model is for use in exchanging compressed channel state information (CSI) between the first node, a second node, and a third node in the communications network, the second node comprising:
a receiver operable to receive from a first node a baseline version of a first component model on CSI data available at the first node;
a memory comprising instruction data representing a set of instructions; and
a processor configured to communicate with the memory and to execute the set of instructions, wherein the second node is configured to:
train a second component model to perform a complementary encoding operation with respect to the baseline version of the first component model, using CSI data available at the second node; and
send a first data product based on the training to the first node, for use by the first node in further training of the first component model.

39-45. (canceled)
